(19) United States
(12) Patent Application Publication
(10) Pub. No.: US 2006/0056726 A1
(43) Pub. Date: Mar. 16, 2006

(54) Image processing device, and program

(75) Inventors: Koichi Fujiwara, Kobe-shi (JP); Osamu Toyama, Kakogawa-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA MEDICAL & GRAPHIC, INC.

(21) Appl. No.: 11/203,788

(22) Filed: Aug. 15, 2005

(30) Foreign Application Priority Data
Aug. 17, 2004 (JP) JP2004-237511

(51) Int. Cl. G06K 9/36

(52) U.S. Cl. 382/276

(57) ABSTRACT

The present invention provides a technique capable of making a user easily grasp a relative position of an ROI in image display by volume rendering and capable of displaying an image promptly. Upon generating an image for display on the basis of volume data by volume rendering, a region of interest (ROI) in a three-dimensional region corresponding to volume data is designated. A first display image portion of the ROI is generated by a normal computing method of a relatively large computation amount. On the other hand, a second display image portion of the region other than the ROI is generated by a simplified computing method of a relatively small computation amount.

This application is based on application No. 2004-237511 filed in Japan, the contents of which are hereby incorporated by reference.

### BACKGROUND OF THE INVENTION

1. Field of the Invention

The present invention relates to a technique of generating an image to be displayed on the basis of volume data.

2. Description of the Background Art

One of methods of visualizing and displaying data showing a three-dimensional structure is volume rendering. The volume rendering is often used for displaying a three-dimensional image that is an image for medical use for the purpose of making a diagnosis in the medical field or the like.

In the image display by the volume rendering, at the time of displaying a region of interest (ROI), conventionally, the ROI and the other region are simultaneously displayed or only the ROI is displayed and the other region is not displayed (for example, Japanese Patent Application Laid-Open No. 2001-52195).

In the case of simultaneously displaying the ROI and the other region, although the relative position of the ROI can be recognized by checking an image of a wide range corresponding to all of volume data, a data computation amount for displaying an image is excessive and long time is required to display an image. On the other hand, when the region other than the ROI is not displayed, an image can be displayed promptly. However, it becomes difficult to grasp the relative position of the ROI in an image of a wide range corresponding to all of the volume data. That is, the technique disclosed in the above publication cannot realize excellent operationality.

### SUMMARY OF THE INVENTION

The present invention is directed to an image processing device for generating an image for display by volume rendering based on volume data.

According to the present invention, the image processing device comprises: a computing method setting part for setting a first computing method of performing volume rendering with a relatively large computation amount per unit volume and a second computing method of performing volume rendering with a relatively small computation amount; a reading part for storing volume data in a three-dimensional region to be processed into a predetermined storage; a designating part for designating a part of the three-dimensional region as a first region, thereby dividing the three-dimensional region into the first region and a second region as the other region; and a generating part for generating a first display image portion by executing the first computing method on a first data portion corresponding to the first region in the volume data and, also, generating a second display image portion by executing the second computing method on a second data portion corresponding to the second region in the volume data.

Since the region other than the ROI can be also visualized with a small computation amount, the relative position of the ROI can be easily grasped in an image display by volume rendering, and an image can be displayed promptly.

The present invention is also directed to a computer software product including a recording medium on which a computer-readable software program is recorded.

Therefore, an object of the present invention is to provide a technique capable of making a user easily grasp a relative position of an ROI in an image display by volume rendering and capable of displaying an image promptly.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating outline of an image processing system according to a preferred embodiment of the present invention;

FIG. 2 is a diagram illustrating volume rendering performed by using ray casting;

FIG. 3 is a diagram illustrating volume rendering performed by using ray casting;

FIG. 4 is a flowchart showing a general operation flow of the volume rendering performed by using the ray casting;

FIG. 5 is a flowchart showing an operation flow of the volume rendering according to the preferred embodiment of the present invention;

FIG. 6 is a diagram illustrating generation of an ROI map;

FIG. 7 is a diagram illustrating a display mode of a display image; and

FIG. 8 is a diagram illustrating a display mode of a display image of a modification.

### DESCRIPTION OF THE PREFERRED EMBODIMENTS

Hereinafter, preferred embodiments of the present invention will be described with reference to the drawings.

(Outline of Image Processing System)

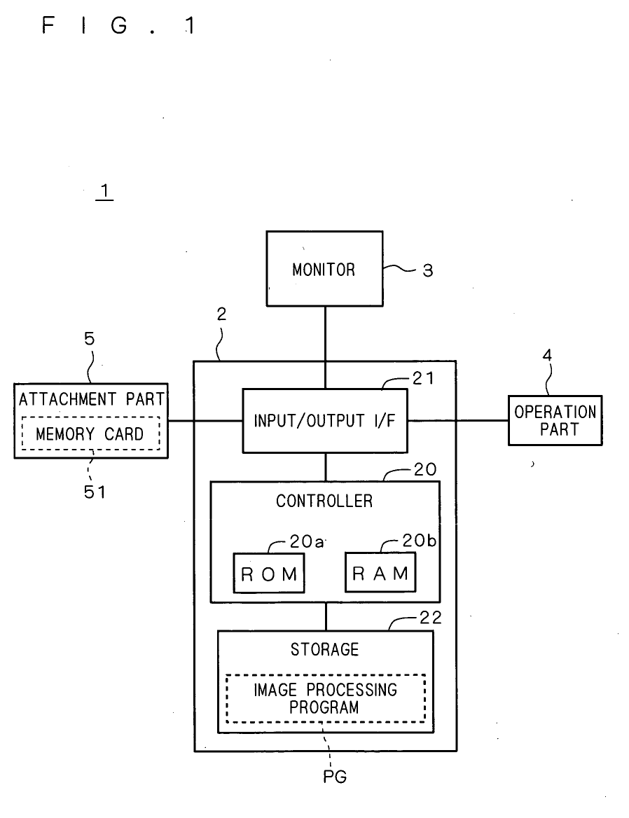

FIG. 1 is a diagram illustrating outline of an image processing system 1 according to a preferred embodiment of the present invention.

The image processing system 1 comprises a personal computer (hereinafter, simply referred to as “PC”) 2, a monitor 3 and an attachment part 5 which are connected to the PC 2 so as to be able to transmit/receive data, and an operation part 4 by which a user enters various selected articles and the like to the PC 2.

The personal computer 2 comprises a controller 20, an input/output I/F 21, and a storage 22.

The input/output I/F 21 is an interface (I/F) for transmitting/receiving data to/from monitor 3, operation part 4 and attachment part 5, and transmits/receives data to/from the controller 20.

The storage 22 takes the form of, for example, a hard disk, and stores an image processing program PG for realizing volume rendering which will be described later, and the like.

The controller 20 mainly includes a CPU, a ROM 20a and a RAM 20b, and is a part for controlling the components of the PC 2 in a centralized manner. The controller 20 reads the image processing program PG stored in the storage 22 and executes it by the CPU, thereby generating image data to be displayed (also referred to as “display image”) by the volume rendering (which will be described later) and outputting the display image to the monitor 3 via the input/output I/F 21. In such a manner, the PC 2 operates as an image processing device for executing the volume rendering which will be described later, and the like.

The monitor 3 takes the form of, for example, a CRT and visibly outputs the display image generated by the controller 20.

The operation part 4 is constructed by a keyboard, a mouse and the like, and transmits various electric signals to the input/output I/F 21 in accordance with various operations of the user. The attachment part 5 can detachably attach a storage medium such as a memory card 51. Various data, programs and the like stored in the memory card 51 attached to the attachment part 5 can be loaded to the controller 20 and the storage 22 via the input/output I/F 21.

(Method of Volume Rendering)

The image processing system 1 according to the preferred embodiment performs the volume rendering by using ray casting, and uses a special computing method for reducing the computation amount.

First, volume rendering performed by using general ray casting will be described. After that, a special computing method of the volume rendering according to the preferred embodiment will be described.

(Volume Rendering Performed by Using General Ray Casting)

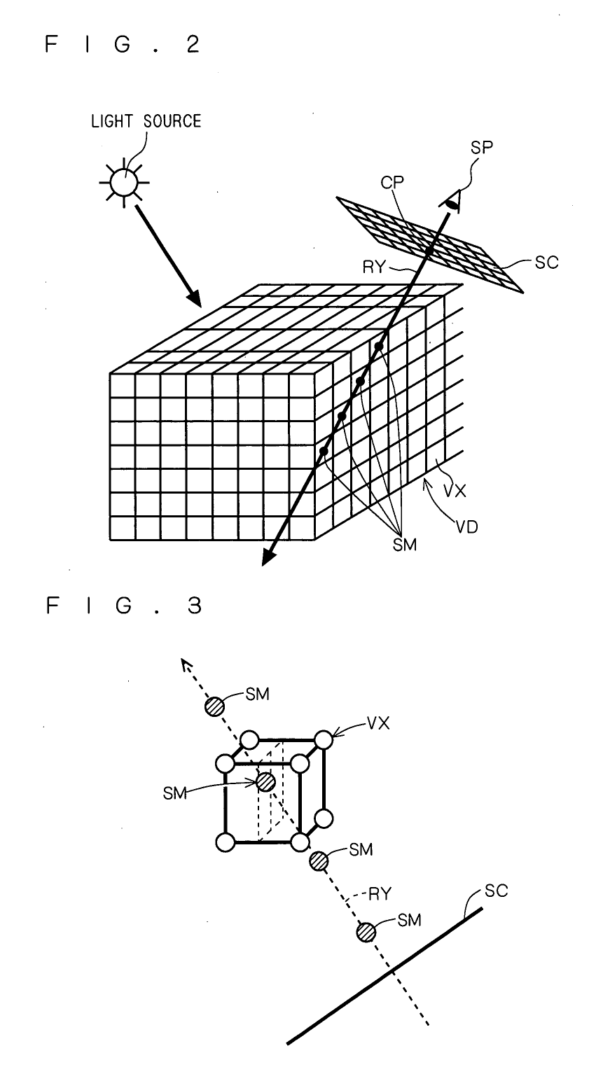

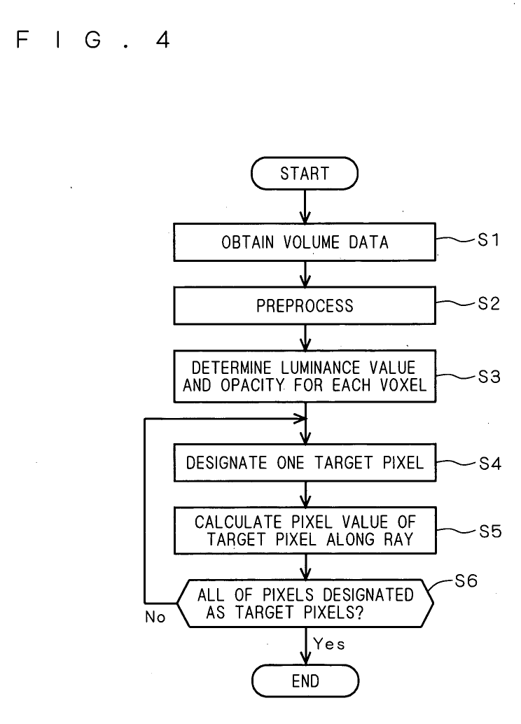

FIGS. 2 and 3 are conceptual diagrams for explaining the volume rendering performed by using ray casting.

A method called “voxel expression” of expressing an object by a set of very small cubes (or rectangular parallelepipeds) as elements is employed here. The cube (or rectangular parallelepiped) as an element is called a voxel.

Generally, by employing CT (Computer Tomography) scan using X rays, an image of a slice of a human body can be obtained. By shifting the position of the slice and changing the slicing direction in the vertical, horizontal and depth directions, data of an X-ray absorption amount included in voxel data is obtained. The data indicative of distribution of concentration or density in a three-dimensional space is called “volume data”. The volume data is data obtained by dividing a three-dimensional region of an object to be expressed by volume data, that is, a three-dimensional region corresponding to volume data into a plurality of voxels and giving one voxel value (in this case, a value indicative of an X-ray absorption amount) for each of the voxels. The three-dimensional region corresponding to the volume data is to be subjected to the computing process in the volume rendering.

In the volume rendering performed by using the ray casting, for example, as shown in FIG. 2, voxel data VD distributed in a three-dimensional space is sampled at sampling points SM at predetermined intervals along a ray (also referred to as visual line) RY emitted from an arbitrary viewpoint SP via a predetermined point CP on a plane SC of projection, and the sampled values are added. As a result, a translucent display image is generated. Each of the point CP on the plane SC of projection corresponds to each of pixels of the display image finally generated and will be also referred to as a “pixel correspondence point” below. A pixel which is being a target of calculation of a pixel value in the pixels on the display image will be also referred to as a “target pixel”. In the volume rendering, the inside of an object is visualized by performing translucent display. This is realized by giving opacity α to each of the voxels VX.

In the volume rendering performed by using the ray casting, a product between the luminance value and the opacity α in respect to each voxel is added up from the viewpoint SP side along the ray RY. When the sum total of α becomes 1 or the ray RY goes out from the target volume, a process on the target pixel (the pixel correspondence point CP corresponding to the target pixel) is finished, and the result of addition is employed as the value (pixel value) of the target pixel.

When the luminance value and the opacity at the present sampling point are set as c and α, respectively, the relation between an integrated luminance value Cin at the sampling point in the visual line and an integrated luminance value Cout after the sampling point is obtained by the following equation (1).
Cout=Cin(1−α)+Ca (1)

As shown in FIG. 3, the luminance value and the opacity in each of the sampling points (hatched circles in FIG. 3) SM in the ray casting are obtained by liner interpolation from the luminance values and opacity of neighboring eight voxels (the center point of each of the voxels is indicated by a blanked circle in FIG. 3).

FIG. 4 is a flowchart showing an operation flow of the volume rendering performed by using general ray casting. In the following description, it is assumed that the operation flow is executed in the image processing system 1.

As shown in FIG. 4, when the operation flow of volume rendering starts, first, volume data stored in the memory card 51, storage 22 or the like is read and obtained by the controller 20 (step S1). The volume data is temporarily stored in the RAM 20b or the like. The controller 20 performs preprocesses such as a filer process for noise removal on the volume data (step S2). After that, the luminance value and the opacity of each voxel are determined (step S3). By adding up products between the luminance value and the opacity from a pixel correspondence point on the plane of projection along the ray, the final pixel value of each of the target pixels is obtained, and a display image is generated (steps S4 to S6).

A method of calculating the luminance “c” and the opacity α of each voxel will now be described.

The luminance value “c” of each voxel is calculated by the following equation (2) based on the Phone shading model by using a normal vector N estimated from the gradient of values of neighboring voxels.

$$c = cpka + \frac{cp}{{k}_{1} + {k}_{2 d}} [ kd ( N \cdot L ) + ks ( N \cdot H ) ] \qquad ( 2 )$$

Herein, cp denotes intensity of a light source, and ka, kd, and ks indicate ratios of environment light, diffusion light and specular reflection light components. “d” indicates distance from the plane of projection to a voxel, and k₁ and k₂ are parameters of depth coding of displaying an image with brightness that decreases with distance from the plane of projection. L denotes a unit direction vector from a voxel to the light source, and H denotes a vector for obtaining regular reflection light and is obtained by the following equation (3) by using a visual line direction vector V indicative of the direction of the ray.
H=(V+L)/|V+L| (3)

The normal vector N of a voxel value f(i, j, k) is obtained by the following equation (4). The voxel value f(i, j, k) is a voxel value in coordinates of x=i, y=j, and z=k of the case where the voxel value f(i, j, k) is expressed in a three-dimensional orthogonal coordinate system of x, y and z.
N=∇f(i, j, k)/|∇f(i, j, k)| (4)

Herein, ∇f(i, j, k) is obtained by the following equation (5) as gradients in the x, y and z directions of the voxel values.

$$\begin{matrix}∇ f ( i , j , k ) = [ ( f ( i + 1 , j , k ) - f ( i - 1 , j , k ) ) , \\ ( f ( i , j + 1 , k ) - f ( i , j - 1 , k ) ) , \\ ( f ( i , j , k + 1 ) - f ( i , j , k + 1 ) ) ]\end{matrix} \qquad ( 5 )$$

In the case of obtaining a color image as the display image obtained by the rendering, for example, by executing similar calculations using the equations (2) to (5) on the components of R (red), G (green) and B (blue) of the light source, pixel values of R, G and B of the target pixel can be obtained.

In the equations (2) to (5), the light source intensity cp, the ratio ka of the environment light component, the ratio kd of the diffusion light component, the ratio ks of the specular reflection light component, and the parameters k1 and k2 of the depth coding are set to proper values by the user. The unit direction vector L is determined by the positional relation between the position setting of the light source and the position of the voxel, and the visual line direction vector V indicative of the direction of the ray is obtained by the position setting of the viewpoint SP. Since all of values of the right side of the equation (2) are obtained, the luminance value “c” of each voxel can be calculated.

On the other hand, the opacity α can be calculated by the following equation (6).
α=αₙ₊₁(f−fₙ)/(fₙ₊₁−fₙ)+αₙ(fₙ₊₁−f)/(fₙ₊₁−fₙ) (6)

Herein, f(i, j, k) is simply indicated as “f”, fₙ denotes the minimum value of the voxel value in the range of voxel values to which opacity is given and fₙ₊₁ denotes the maximum value of the voxel value in the range of the voxel values to which opacity is given. In addition, αₙ denotes opacity when the voxel value is fₙ, and αₙ₊₁ denotes opacity when the voxel value is fₙ₊₁. The opacity is obtained by the equation (6) when the relation of “fₙ<f<fₙ₊₁” is satisfied. When the relation of “fₙ<f<fₙ₊₁” is not satisfied, α is set to zero (α=0).

(Volume Rendering According to the Preferred Embodiment)

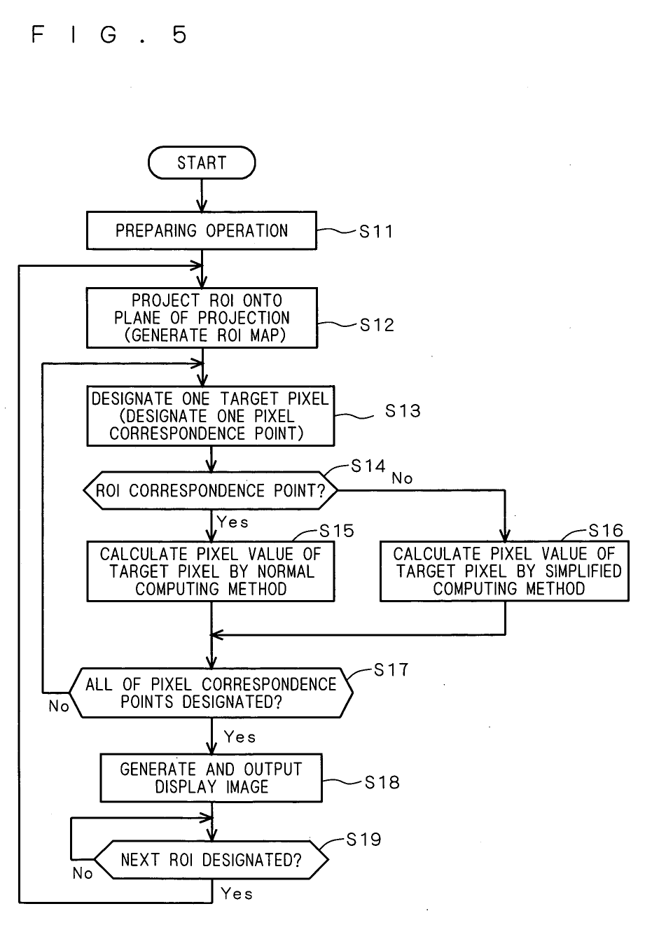

FIG. 5 is a flowchart showing an operation flow of volume rendering according to the preferred embodiment of the present invention. The operation flow is realized when the controller 20 reads and executes the image processing program PG stored in the storage 22. First, when the volume rendering operation (operation of generating a display image) in the image processing system 1 starts in response to various operations on the operation part 4 by the user, the program advances to step S11 in FIG. 5.

In step S11, a preparing operation is performed and the program advances to step S12. In the preparing operation, operations similar to the operations shown in step S1 to S3 in FIG. 4 are performed. For example, as described above, volume data stored in the memory card 51, storage 22 or the like is read and obtained by the controller 20 and is loaded and temporarily stored into the RAM 20b. Preprocesses such as a filter process for noise removal are performed on the volume data and, after that, the luminance value and the opacity of each voxel are determined. Volume data to be read can be properly designated from a plurality of pieces of volume data stored in the memory card 51, storage 22 and the like by variously operating the operation part 4 by the user.

In step S12, a region of interest (ROI) is projected on the plane of projection to generate an ROI map. The program advances to step S13.

The plane of projection has pixel correspondence points corresponding to pixels of the display image finally generated, and is set according to various operations on the operation part 4 by the user, the image processing program PG, or the like. The viewpoint of emission of the ray is similarly set according to various operations on the operation part 4 by the user, the image processing program PG, or the like.

The region of interest (ROI) is a region the user particularly wishes to observe with attention and a region of a part which is desired to be displayed more vivid than the other region in an image displayed on the basis of the finally generated display image in the three-dimensional region corresponding to the volume data. The ROI is designated by the controller 20 in accordance with various operations on the operation part 4 by the user, the image processing program PG, or the like.

When a ray is emitted from a viewpoint so as to pass through the pixel correspondence points on the plane of projection, the ROI map is data indicative of coordinates of the pixel correspondence points through which the ray incident on the ROI passes (hereinafter, also referred to as “ROI correspondence points”) among all of pixel correspondence points on the plane of projection.

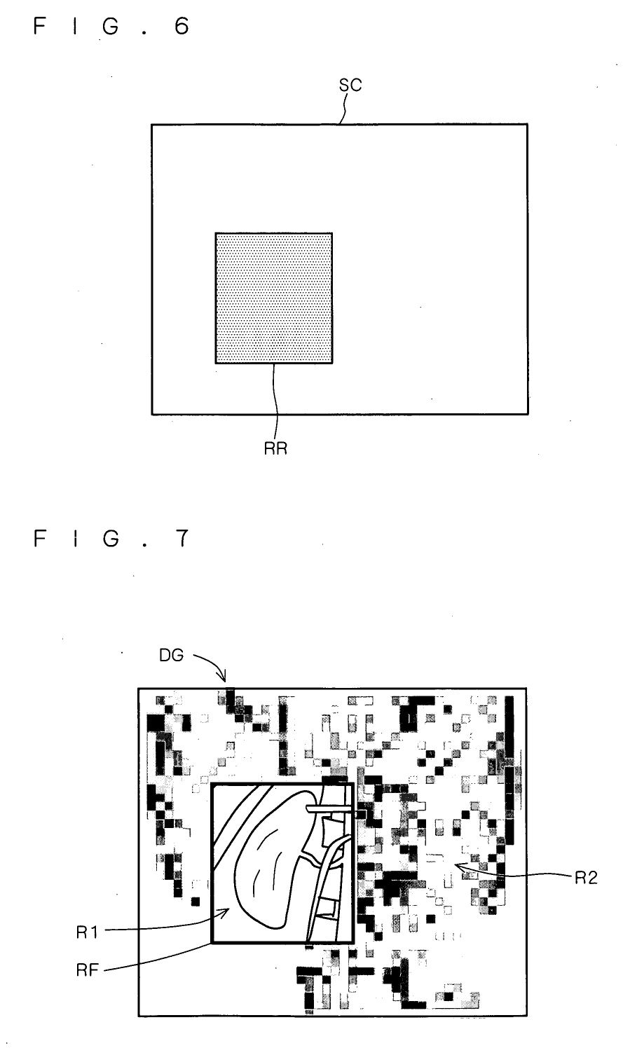

FIG. 6 is a diagram illustrating generation of an ROI map. For example, in the case where the ROI is a rectangular parallelepiped region, as shown in FIG. 6, when the ROI is projected to the plane SC of projection, an region (hatched region) RR corresponding to the rectangular ROI is generated. Data indicative of coordinates of each of pixel correspondence points (ROI corresponding point) in the region RR on the plane SC of projection is generated as an ROI map. The ROI map generated in such a manner is data indicating whether a pixel correspondence point is a pixel correspondence point (ROI correspondence point) corresponding to the ROI or not on the basis of the coordinates of each of pixel correspondence points on the plane SC of projection.

In step S13, one target pixel, that is, one pixel correspondence point on the plane of projection is designated, and the program advances to step S14. In step S13, the pixel correspondence point at which a pixel value is calculated for generating a display image is designated as a target pixel. Each time program returns to step S13 from step S17 which will be described later, one pixel correspondence point is designated. For example, the pixel correspondence point is designated sequentially from the pixel correspondence point in the upper left position of the plane SC of projection shown in FIG. 6 one by one from left to right. After the pixel correspondence points are designated to the right end, the pixel correspondence points in the lower line are sequentially designated one by one from left to right. In the following, it will be described on assumption that the pixel correspondence points on the plane of projection are sequentially designated one by one from left to right from the uppermost line to the lowest line in step SI 3.

In step S14, by referring to the ROI map generated in step S12, whether the pixel correspondence point designated in step S13 is an ROI correspondence point or not. If the pixel correspondence point is an ROI correspondence point, the program advances to step S15. If the pixel correspondence point is not an ROI correspondence point, the program advances to step S16.

In step S15, the pixel value of the target pixel presently designated is calculated by the above-described volume rendering performed by using general ray casting, and the program advances to step S17. At this time, only sampling points at predetermined intervals along a ray, which are included in the ROI are sampled. That is, regions on the front and rear sides of the ROI (that is, the region out of the ROI) along the ray passing the ROI in a three-dimensional region corresponding to volume data are not sampled.

As described above, in step S15, with respect to all of designated target pixels (pixel correspondence points corresponding to target pixels), the pixel values of the target pixels corresponding to the ROI are calculated on the basis of the volume data (also referred to as “first data portion”) of the ROI by a computing method (hereinafter, also referred to as “normal computing method”) for sampling volume data at predetermined intervals along a predetermined visual line. As a result, a display image of the ROI (also referred to as “first display image portion”) is generated.

In step S16, the pixel values of the target pixels presently designated are calculated by a simplified computing method, and the program advances to step S17. The simplified computing method herein is a computing method for calculating a pixel value in accordance with the volume rendering performed by general ray casting for each fixed pixel intervals (for example, every four pixels and the like).

More concretely, for example, with respect to a region constructed by pixel correspondence points other than ROI correspondence points on the plane of projection, when the pixel value of one pixel correspondence point (that is, target pixel) is calculated in accordance with the volume rendering performed by using general ray casting, the same pixel value is employed for total 16 pixels of four pixels on the right side of the target pixel as the upper left reference whose pixel value is calculated by four pixels below the target pixel. In other words, pixel values are calculated in accordance with the volume rendering performed by using general ray casting every four pixels in the vertical and horizontal directions. For skipped pixels between the pixels, the calculated pixel value of the neighboring pixel is employed. That is, as the pixel value of a target pixel (also referred to as “pixel not to be rendered”) other than a target pixel (also referred to as “pixel to be rendered”) having a pixel value calculated in accordance with the volume rendering performed by using general ray casting, the calculated pixel value of the pixel to be rendered in the vicinity of the pixel not to be rendered is employed.

On the basis of volume data (also referred to as “second data portion”) of a region out of the ROI (also referred to as “ROI outside region”) in the three-dimensional region corresponding to volume data, the pixel values of pixels corresponding to the ROI outside region are calculated by the simplified computing method. As a result, a display image outside of the ROI region (referred to as “second display image portion”) is generated.

As described above, in the simplified computing method, a small number of target pixels obtained by reducing the number of all of pixels (that is, a pixel region) corresponding to a display image except for the ROI in accordance with a predetermined rule (rule of picking up one pixel out of the total 16 pixels of 4 pixels in the vertical direction by 4 pixels in the horizontal direction) are subjected to sampling at predetermined intervals along a predetermined visual line on volume data, thereby calculating the pixel values of the resultant small number of target pixels. Consequently, the sampling on volume data is performed on target pixels (pixels to be rendered) which exist at relatively low density in a display image in the simplified computing method as compared with the normal computing method. That is, the computation amount on a three-dimensional region corresponding to the volume data in the simplified computing method employed in step S16 is relatively smaller than that in the normal computing method employed in step S15 of the operation flow. In other words, the simplified computing method performs volume rendering per unit volume with a computation amount smaller than that of the normal computing method.

In step S17, whether all of pixel correspondence points on the plane of projection have been designated or not is determined. If NO, the program returns to step S13 and repeats the processes from step S13 to step S17 until all of pixel correspondence points are designated. If YES, the program advances to step S18.

In step S18, display image data (image for display) is generated on the basis of the pixel values calculated in steps S15 and S16 and output to the monitor 3. After that, the program advances to step S19. By outputting the display image data to the monitor 3, a display image based on the display image data is visibly output (displayed) on the monitor 3.

Therefore, in the operation flow, the computing method is switched and selected between the normal computing method and the simplified computing method. In accordance with the computing method selected at each of the stages and a designated ROI, an image for display is generated on the basis of volume data by volume rendering.

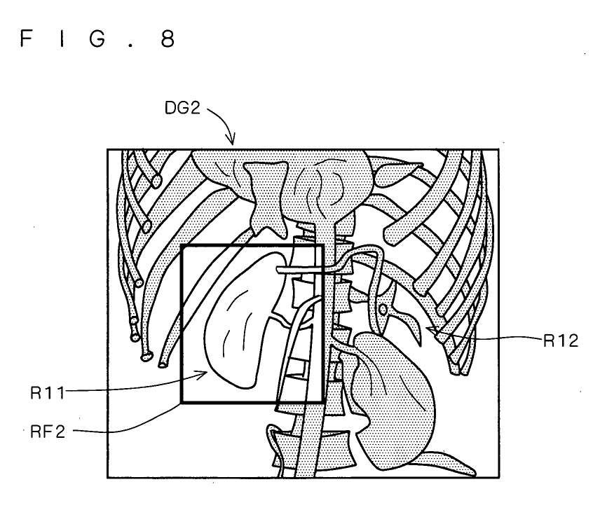

FIG. 7 is a diagram illustrating a display mode of a display image which is displayed on the basis of the image for display. FIG. 7 illustrates a display mode of a display image DG visibly output onto the monitor 3. A thick frame RF in FIG. 7 is superimposed on the display image DG as a mark indicative of the position corresponding to the outer frame of the ROI.

As described above, the pixel value of an ROI correspondence point is calculated in accordance with the volume rendering performed by using the general ray casting, and the pixel values of the other pixel correspondence points are calculated by the simplified method. Consequently, as shown in FIG. 7, an image in an image region R1 in the thick frame RF becomes clear by the volume rendering performed by the general ray casting in the display image DG An image in an image region R2 out of the thick frame RF becomes a (mosaic) image obtained by calculating the pixel values while skipping pixels. In such a display mode, although the picture quality deteriorates in the region out of the thick frame RF, in the thick frame RF, the picture quality is excellent, and a clear image is obtained. The user can also see wide range out of the ROI. That is, the relative position of the ROI can be easily grasped. With respect to a region constructed by pixel correspondence points other than the ROI correspondence points in the plane of projection, the calculation amount by volume rendering requiring a large calculation amount can be reduced by employing the simplified computing method. Thus, an image for display can be generated more quickly, and a display image based on the image for display can be displayed.

Referring again to FIG. 5, the description will be continued.

In step S19, whether the next ROI is determined by various operations on the operation part 4 by the user or not is determined. Until the next ROI is designated, determination in step S19 is repeated. When the next ROI is designated, the program returns to step S12. By the processes of steps S12 to S19, an image for display is generated on the basis of the next ROI, and a display image is displayed on the monitor 3.

Although not shown, when end of the volume rendering operation in the image processing system 1 is selected by various operations of the user on the operation part 4, the operation flow shown in FIG. 5 is forcedly finished.

As described above, in the image processing system 1 according to the preferred embodiment of the present invention, at the time of generating an image for display on the basis of volume data by the volume rendering, the ROI as a part of the three-dimensional region corresponding to the volume data is designated. The normal computing method of generating an image for display of the ROI and the simplified computing method of generating an image for display of the region out of the ROI are set so that the computation amount of the simplified computing method is relatively smaller than that of the normal computing method. Consequently, volume data in the region out of the ROI can be visualized with a small computation amount. As a result, in an image display by volume rendering, the relative position of the ROI in the three-dimensional region corresponding to the volume data can be easily visually grasped by the user, and prompt image display can be also achieved.

In the simplified computing method of generating an image for display of the region out of the ROI, at the time of performing sampling at predetermined intervals along a predetermined visual line on the volume data, pixel values of pixels which exist at relatively low density in the image for display as compared with that in the normal computing method for generating an image for display of the ROI are calculated. By employing such a configuration, although an image of the region out of the ROI becomes rough, an image for display in the wide region also including the region out of the ROI can be generated with a small computation amount. As a result, an image for display in which the relative position of the ROI in the three-dimensional region corresponding to the volume data can be easily visually grasped by the user can be displayed promptly.

Further, for the region out of the ROI, as pixel values other than the pixels to be rendered, pixel values calculated on pixels to be rendered around the ROI are employed. With such a configuration, although the picture quality deteriorates, a relatively natural image for display without a pixel drop can be generated. Consequently, the relative position of the ROI in the three-dimensional region corresponding to the volume data can be visually easily grasped by the user.

(Modifications)

Although the preferred embodiment of the present invention has been described above, the present invention is not limited to the above description.

For example, in the above preferred embodiment, pixel values are calculated in accordance with the volume rendering performed by using the general ray casting at predetermined pixel intervals such as every four pixels by the simplified computing method. The present invention is not limited to the computing method, but pixel values may be calculated in accordance with volume rendering performed by using the general ray casting at predetermined pixel intervals such as every two pixels.

The intervals of pixels having pixel values calculated by the method of volume rendering performed by using the general ray casting may be properly changed by various operations on the operation part 4 by the user. With such a configuration, the user can adjust the balance between the picture quality and the display speed of a display image in the region out of the ROI.

In the above preferred embodiment, by the setting of performing the sampling at predetermined intervals along a predetermined visual line on volume data on pixels provided at relatively low density in the region out of the ROI, the computation amount of the simplified computing method is relatively smaller than that of the normal computing method. However, the present invention is not limited to the setting. A setting may be made so that the computation amount of the simplified computing method for generating an image for display of the region out of the ROI becomes smaller than that of the normal computing method for generating an image for display of the ROI by employing another simplified computing method.

Three simplified computing methods will be described below as the other simplified computing methods.

(Example 1 of Simplified Computing Method)

In the case of performing sampling at sampling points at predetermined intervals H along a ray emitted via pixel correspondence points on a plane of projection from an arbitrary view point in a normal computing method on voxel data in an ROI, as a simplified computing method on the voxel data in the region out of the ROI, a computing method of performing sampling at sampling points at predetermined intervals H2 wider than the predetermined intervals H along the ray emitted via the pixel correspondence points on the plane of projection from the arbitrary view point may be employed.

Specifically, the normal computing method and the simplified computing method in this case are similar to each other with respect to the point that pixel values of an image for display are calculated by performing sampling at predetermined intervals along a predetermined visual line on volume data. However, the distance between neighboring sampling points (predetermined interval) of the simplified computing method is relatively longer than that of the normal computing method. By such a setting, the number of sampling points in the simplified computing method is relatively smaller than that of the normal computing method. Consequently, the computation amount of the three-dimensional region corresponding to the volume data of the simplified computing method becomes relatively smaller than that of the normal computing method.

FIG. 8 is a diagram showing a display mode of a display image in the modification. FIG. 8 schematically illustrates a display mode of a display image DG2 visually output to the monitor 3. The thick frame RF2 in FIG. 8 is superimposed on the display image DG2 as a mark indicative of the position corresponding to the outer frame of the ROI.

As described above, the pixel value of an ROI correspondence point is calculated by the normal computing method, and the pixel values of the other pixel correspondence points are calculated by the simplified computing method. In the display image DG2 shown in FIG. 8, with respect to an image region R11 in the thick frame RF2 is sampled at, for example, finer predetermined intervals (step widths), so that the image of an image region R11 becomes clear. With respect to an image region R12 out of the thick frame RF2, the number of sampling points is small, so that the picture quality deteriorates (hatched portion in FIG. 8).

By such a display mode, in the region of the thick frame RF2, the picture quality is excellent, and a clear image is obtained. In the region out of the thick frame RF2, although the picture quality deteriorates, the user can also see wide around the ROI. That is, the user can grasp visually easily the relative position of the ROI in the three-dimensional region corresponding to the volume data. With respect to a region constructed by pixel correspondence points other than the ROI correspondence points, the calculation amount by volume rendering requiring a large calculation amount can be reduced by employing the simplified computing method. Thus, an image for display can be generated more quickly, and a display image based on the image for display can be displayed.

By employing the configuration, although the picture quality deteriorates in the region out of the ROI, computation for generating an image can be performed at high speed. As a result, an image in which the relative position of the ROI in the three-dimensional region corresponding to the volume data can be easily visually grasped by the user can be displayed promptly.

(Example 2 of Simplified Computing Method)

In the above preferred embodiment, when operation of volume rendering (operation of generating an image for display) starts, the luminance value and opacity of each voxel are determined in/out of the ROI. The present invention is not limited to the method. For example, in step S15, the luminance value and opacity of each voxel are not calculated in a preparing operation in step S11 in FIG. 5 but the luminance value and opacity at each voxel adjacent to the sampling point in the ROI are calculated by using the above equations (2) to (6). In step S16, with respect to each of voxels in the region out of the ROI, the luminance value and opacity of each voxel adjacent to each sampling point are not calculated by using the above equations (2) to (6), but a predetermined luminance value and predetermined opacity may be given to a voxel to which a voxel value in a predetermined value range is given. In the simplified computing method of this case, a predetermined luminance value and predetermined opacity are given to a voxel to which a voxel value in a predetermined value range is given to generate an image for display in the region out of the ROI.

For example, in step S16, a voxel value corresponding to each sampling point in the region out of the ROI is obtained by linear interpolation from voxel values given to voxels adjacent in eight directions. In the case where the voxel value corresponding to a sampling point lies in a predetermined value range, a predetermined luminance value and predetermined opacity are given to the sampling point. In such a manner, an image for display of the region out of the ROI may be generated.

The computation amount on the luminance value and opacity in any of the simplified computing methods is much smaller than that in the normal computing method. Consequently, the computation amount on a three-dimensional region corresponding to volume data in the simplified computing method is relatively smaller than that in the normal computing method.

With such a configuration, as the display image DG2 displayed on the basis of the generated image for display in an image region R11 of the thick frame RF2, a clear image is obtained by the volume rendering performed by using the general ray casting as shown in FIG. 8. On the other hand, with respect to an image region R12 out of the thick line RF2, the pixel value is calculated by giving a predetermined luminance value and predetermined opacity in correspondence with a voxel value in a predetermined value range. Consequently, a mode of displaying an object is extremely monotonous with hardly any variations in colors and brightness (hatched portions in FIG. 8). However, in the region out of the ROI, calculation of the luminance value and opacity can be largely omitted, so that the computation amount necessary for generating an image of the region out of the ROI can be reduced. As a result, an image in which the relative position of the ROI in a three-dimensional region corresponding to volume data is easily visually grasped by the user can be displayed promptly.

(Example 3 of Simplified Computing Method)

In the above preferred embodiment, when the volume rendering operation (operation of generating an image for display) starts, the luminance value and opacity of each voxel are determined in/out of the ROI. The present invention, however, is not limited to the preferred embodiment. For example, the luminance value and opacity of each voxel are not calculated in the preparing operation in step S11 of FIG. 5 but the luminance value and opacity of each of voxels adjacent to each of sampling points in the ROI are calculated by using the above equations (2) to (6) in step S15. On the other hand, in the region out of the ROI, pixel values are not calculated by volume rendering performed by using the general ray casting, but a pixel value (color value) of RGB according to the distance from the plane of projection used in the volume rendering in a three-dimensional region corresponding to volume data to the surface of a predetermined object expressed by the volume data (hereinafter, also referred to as “depth value”) may be given to each pixel.

For example, by connecting voxels having voxel values in a predetermined value range on the surface of a triangle or the like, the surface of a predetermined object corresponding to the voxel values in the predetermined value range can be falsely generated. By obtaining the distance (depth value) between the surface of the predetermined object falsely generated and the plane of projection at each of all of pixel correspondence points on the plane of projection, a map indicative of the depth values (hereinafter, also referred to as “depth map”) from the plane of projection to the surface of the predetermined object can be generated. The depth map may be generated in, for example, step S12 in FIG. 5.

As described above, by detecting the distance from the plane of projection to the point corresponding to the pseudo surface of an object corresponding to voxel values in the predetermined value range along each of visual lines passing the pixel corresponding points on the plane of projection, a depth map can be generated. In step S16 in FIG. 5, a simplified computing method of designating a pixel value (display color) according to the depth value in the depth map to each of pixels constructing an image for display corresponding to the region out of the ROI may be executed. The distance between the plane of projection to the point corresponding to the pseudo surface of an object corresponding to voxel values in the predetermined value range can be also regarded as a distance from the plane of projection to a voxel to which a voxel value in a predetermined value range is given.

More concretely, for example, it is sufficient to designate a pixel value indicative of red to a pixel correspondence point (that is, a target pixel) having a depth value detected as the farthest (largest) one from the plane of projection, and designate a pixel value indicative of white to a pixel correspondence point (that is, a target pixel) having a depth value detected as the closest (smallest) one from the plane of projection. It is sufficient to designate a pixel value indicative of a color between red and white by linear interpolation to a depth value which is neither maximum nor minimum. In this case, for example, only a pixel value of red is given and the level of the pixel value of red may be properly changed according to the depth value.

With such a configuration, although a mode of displaying an object in the region out of the ROI in accordance with distances is extremely monotonous, the computation amount necessary for generating an image of the region out of the ROI can be largely reduced as compared with that in the normal computing method. As a result, the region out of the ROI can be also visualized with a small computation amount, and an image in which the relative position of the ROI in a three-dimensional region corresponding to volume data is easily visually grasped by the user can be displayed promptly.

Although the volume rendering by using the ray casting was performed in the above preferred embodiment, the present invention is not limited to the method. For example, other volume rendering such as splatting may be performed. That is, the present invention can be applied to cases of generating an image for display on the basis of volume data by volume rendering using various methods.

In the above preferred embodiment, volume data is obtained by using a CT scan with X-rays. The present invention is not limited to the CT scan but volume data may be obtained on the basis of a result of simulation of any of various physical quantity analyses of reflected waves of ultrasonic waves (echo) and the like.

While the invention has been shown and described in detail, the foregoing description is in all aspects illustrative and not restrictive. It is therefore understood that numerous modifications and variations can be devised without departing from the scope of the invention.

What is claimed is:

1. An image processing device for generating an image for display by volume rendering based on volume data, comprising:
a computing method setting part for setting a first computing method of performing volume rendering with a relatively large computation amount per unit volume and a second computing method of performing volume rendering with a relatively small computation amount;
a reading part for storing volume data in a three-dimensional region to be processed into a predetermined storage;
a designating part for designating a part of said three-dimensional region as a first region, thereby dividing said three-dimensional region into said first region and a second region as the other region; and
a generating part for generating a first display image portion by executing said first computing method on a first data portion corresponding to said first region in said volume data and, also, generating a second display image portion by executing said second computing method on a second data portion corresponding to said second region in said volume data.

2. The image processing device according to claim 1, wherein
said first and second computing methods are computing methods of sampling said volume data along each of visual lines and, by computations based on data sampled by said sampling, obtaining pixel values in said first and second display image portions, and
said sampling is performed so that pixel density of said second display image portion becomes lower than that of said first display image portion.

3. The image processing device according to claim 2, wherein
said second computing method is a computing method of employing, as a pixel value of a pixel which is not to be subjected to said sampling and computation, a pixel value obtained regarding a pixel which is positioned in the vicinity of said pixel which is not to be subjected to said sampling and computation and is to be subjected to said sampling and computation.

4. The image processing device according to claim 1, wherein
said first and second computing methods are computing methods of sampling said volume data along each of visual lines and, by computations based on data sampled by said sampling, obtaining pixel values in said first and second display image portions, and
a sampling interval in said second computing method is larger than that in said first computing method.

5. The image processing device according to claim 1, wherein
said volume data is data obtained by dividing said three-dimensional region into a plurality of voxels and giving a voxel value to each of said voxels, and
said second computing method is a computing method of generating said second display image portion by giving a predetermined luminance value and predetermined opacity to a voxel to which a voxel value in a predetermined value range is given.

6. The image processing device according to claim 1, wherein
said first and second computing methods are computing methods of sampling said volume data along each of visual lines and, by computations based on data sampled by said sampling, obtaining pixel values in said first and second display image portions, and
said second computing method is a computing method of generating said second display image portion by giving a predetermined luminance value and predetermined opacity to a sampling point when a voxel value of said sampling point lies in a predetermined value range.

7. The image processing device according to claim 1, wherein
said volume data is data obtained by dividing said three-dimensional region into a plurality of voxels and giving a voxel value to each of said voxels,
said image processing device further comprises a detector for specifying a pseudo surface of an object constructed by a portion having voxel values in a predetermined value range in said volume data, and detecting a distance from a predetermined plane of projection used for said volume rendering to said pseudo surface along each of visual lines passing correspondence points corresponding to pixels of said image for display in said predetermined plane of projection, and
said second computing method is a computing method of designating a display color according to a distance from each of correspondence points corresponding to pixels in said second display image portion to said pseudo surface to each of said pixels of said image for display on the basis of a result of detection by said detector.

8. The image processing device according to claim 1, wherein
said first region is designated by a user.

9. The image processing device according to claim 1, wherein
said first region is designated on the basis of a map generated on a plane of projection which is arbitrarily set.

10. A computer software product including a recording medium on which a computer-readable software program is recorded, said software program for controlling a computer to operate as an image processing device for generating an image for display by volume rendering based on volume data, said image processing device comprising:
a computing method setting part for setting a first computing method of performing volume rendering with a relatively large computation amount per unit volume and a second computing method of performing volume rendering with a relatively small computation amount;
a reading part for storing volume data in a three-dimensional region to be processed into a predetermined storage;
a designating part for designating a part of said three-dimensional region as a first region, thereby dividing said three-dimensional region into said first region and a second region as the other region; and
a generating part for generating a first display image portion by executing said first computing method on a first data portion corresponding to said first region in said volume data and, also, generating a second display image portion by executing said second computing method on a second data portion corresponding to said second region in said volume data.

11. The computer software product according to claim 10, wherein
said first and second computing methods are computing methods of sampling said volume data along each of visual lines and, by computations based on data sampled by said sampling, obtaining pixel values in said first and second display image portions, and
said sampling is performed so that pixel density of said second display image portion becomes lower than that of said first display image portion.

12. The computer software product according to claim 11, wherein
said second computing method is a computing method of employing, as a pixel value of a pixel which is not to be subjected to said sampling and computation, a pixel value obtained regarding a pixel which is positioned in the vicinity of said pixel which is not to be subjected to said sampling and computation and is to be subjected to said sampling and computation.

13. The computer software product according to claim 10, wherein
said first and second computing methods are computing methods of sampling said volume data along each of visual lines and, by computations based on data sampled by said sampling, obtaining pixel values in said first and second display image portions, and
a sampling interval in said second computing method is larger than that in said first computing method.

14. The computer software product according to claim 10, wherein
said volume data is data obtained by dividing said three-dimensional region into a plurality of voxels and giving a voxel value to each of said voxels, and
said second computing method is a computing method of generating said second display image portion by giving a predetermined luminance value and predetermined opacity to a voxel to which a voxel value in a predetermined value range is given.

15. The computer software product according to claim 10, wherein
said first and second computing methods are computing methods of sampling said volume data along each of visual lines and, by computations based on data sampled by said sampling, obtaining pixel values in said first and second display image portions, and
said second computing method is a computing method of generating said second display image portion by giving a predetermined luminance value and predetermined opacity to a sampling point when a voxel value of said sampling point lies in a predetermined value range.

16. The computer software product according to claim 10, wherein
said volume data is data obtained by dividing said three-dimensional region into a plurality of voxels and giving a voxel value to each of said voxels,
said image processing device further comprises a detector for specifying a pseudo surface of an object constructed by a portion having voxel values in a predetermined value range in said volume data, and detecting a distance from a predetermined plane of projection used for said volume rendering to said pseudo surface along each of visual lines passing correspondence points corresponding to pixels of said image for display in said predetermined plane of projection, and
said second computing method is a computing method of designating a display color according to a distance from each of correspondence points corresponding to pixels in said second display image portion to said pseudo surface to each of said pixels of said image for display on the basis of a result of detection by said detector.

17. The computer software product according to claim 10, wherein
said first region is designated by a user.

18. The computer software product according to claim 10, wherein
said first region is designated on the basis of a map generated on a plane of projection which is arbitrarily set.
